(19) United States
(12) Patent Application Publication
(10) Pub. No.: US 2003/0072994 A1
(43) Pub. Date: Apr. 17, 2003

(54) Battery pack

(75) Inventors: Takashi Goushu, Utsunomiya-Shi (JP); Koichi Fujitsuka, Utsunomiya-Shi (JP)

Correspondence Address: ARMSTRONG,WESTERMAN & HATTORI, LLP, 1725 K STREET, NW, SUITE 1000, WASHINGTON, DC, 20006, US

(73) Assignee: NEC TOKIN TOCHIGI, LTD, Utsunomiyu-Shi (JP)

(21) Appl. No.: 10/269,863

(22) Filed: Oct. 15, 2002

(30) Foreign Application Priority Data
Oct. 16, 2001 (JP) 2001-318137

(51) Int. Cl. H01M 2/02

(52) U.S. Cl. 429/127; 429/163

(57) ABSTRACT

The invention provides a battery pack that comprises a battery covered with a flexible outer member and is not susceptible to damage even upon receipt of external impacts. In the battery pack, a built-in part including at least a protective circuit board is provided thereon with a cushioning member that is deformable by compression and restorable into shape after decompression. The cushioning member is attached to the surface of the battery by means of a thermally shrinkable tube or an adhesive tape applied on the side of a battery can.

### BACKGROUND OF THE INVENTION

The present invention relates generally to a battery pack, and more particularly to a battery pack called a soft pack that is covered with a flexible synthetic resin or the like.

Batteries of high change/recharge capacity densities, for instance, lithium ion batteries are little used by themselves; they are ordinarily used in the form of a battery pack to be mounted on battery-powered equipments. One such pack comprises a synthetic resin case or enclosure including built-in components such as a charge/recharge protective circuit for cutting off an electric current to protect a battery when an excessive current is induced due to short-circuiting of battery terminals, etc., or at the time of overdischarge resulting from an overheated battery, etc., and a PTC element.

The battery pack is generally broken down into two types, one type wherein a case with built-in components received therein together with a battery is provided on its surface with an electrically conductive connection terminal, and the other called a soft pack wherein a battery and built-in components are covered with a thin synthetic resin film or the like, and the resin film is provided with an electrically conductive connection terminal for connection to associated electronic equipments.

In the battery pack with a battery and built-in components received in a case formed of a synthetic resin or the like, there is no need for providing any protective member for protecting the battery and built-in components against impacts, because the battery and built-in components are already protected by the case.

In the case of the soft pack, however, there is need for protecting a battery and built-in components against external impacts such as those applied to the battery pack when it is dumped.

FIGS. 3(A), 3(B) and 3(C) are illustrative of one example of a conventional battery pack.

FIG. 3(A) is a sectional schematic illustrative of the battery pack. A battery pack shown generally at 1 comprises a battery can 2. The battery can 2 is provided at its surface with a built-in part 3 comprising a battery protective circuit, etc., and a protective member 4 for protecting the built-in part 3 and its upper surface is attached in place. Then, a flexible outer member 5 is provided all over the battery assembly, and an electrically conductive connection terminal 6 is provided for connection to external equipments.

To keep pace with the downsizing of battery-powered equipments, battery packs now become thinner and thinner and so are electronic parts to be mounted to built-in components. However, electronic parts used for protective circuits, etc. become inevitably larger than signal-dedicated parts for the purpose of carrying charge/discharge currents from a battery thereto in a stable manner.

As can be seen from the FIG. 3(B) sectional view of the battery pack, when a battery 2 received in a battery pack 1 is slimmed down in such a way as to be compatible with downsized equipments, and especially when the battery 2 is configured at a thickness equivalent to the size of a built-in part 3, it is virtually impossible to attach a protective member 4 thereto, because that member 4 extends across the battery, projecting from both its sides.

As can be understood from FIG. 3(C) that is a sectional schematic of the battery pack vertical to its thickness direction, when a lengthwise protective member 4A extending in the lengthwise direction of a battery is attached to the surface of the battery pack to which a built-in part 3 is attached, the lengthwise protective member 4A deflects; when external impacts are applied on the battery pack, the built-in part may possibly break down, because the central portion of the lengthwise protective member 4A deflects as shown by a dotted line, colliding with the built-in part.

### BRIEF DESCRIPTON OF THE DRAWINGS

FIG. 1 is a sectional view illustrative of one embodiment of the battery pack according to the invention.

FIGS. 2(A) to 2(E) are illustrative of one embodiment of the battery pack production process according to the invention.

FIGS. 3(A), 3(B) and 3(C) are illustrative of one example of a conventional battery pack.

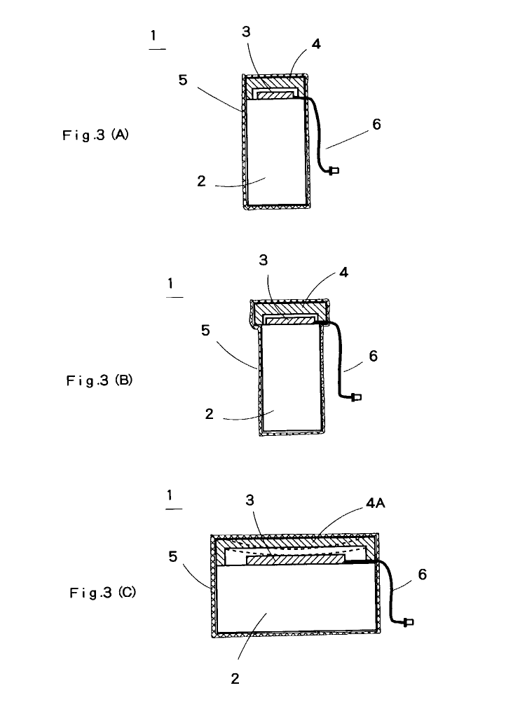

### SUMMARY OF THE INVENTION

The present invention provides a battery pack comprising a battery covered with a flexible member, wherein a built-in part including at least a protective circuit board is provided thereon with a cushioning member that is deformable by compression and restorable into shape after decompression.

In the battery pack of the invention, the cushioning member is at least one electrical insulating member selected from the group consisting of a foamed synthetic resin and a foamed rubber.

In the battery pack of the invention, the cushioning member is attached to the surface of the battery by means of a thermally shrinkable tube.

In the battery pack of the invention, the built-in part is attached to the surface of the battery by means of an adhesive tape.

### DESCRIPTION OF THE PREFERRED EMBODIMENT

According to the present invention, it has now been found that by attachment of a cushioning member that is deformable by compression and restorable into shape after decompression by means of a thermally shrinkable tube or an adhesive tape, it is possible to provide a battery pack which, even when uses a slimline battery, provides protection of a built-in part including a protective circuit against external impacts, and free from any thickness increase by a protective member for the built-in part.

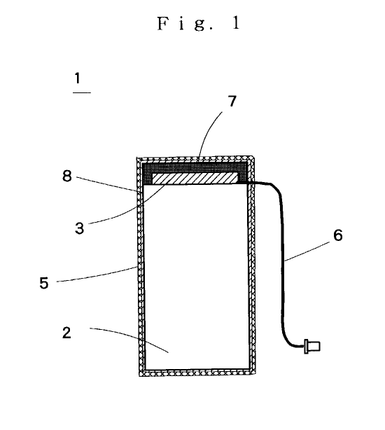

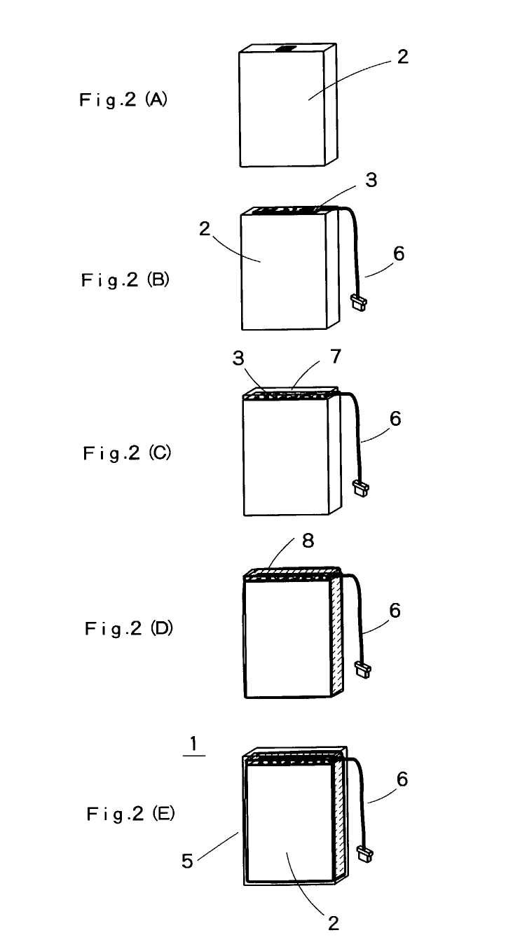

The present invention is now explained with reference to FIGS. 1 and 2.

FIG. 1 is a sectional view illustrative of one embodiment of the battery pack according to the present invention.

In a battery pack 1 of the present invention, a built-in part 3 including a battery protective circuit, etc. is attached to the surface of a battery 2. The built-in part 3 is provided thereon with a cushioning member 7 that is deformed by compression and restored into shape after decompression. This cushioning member 7 is fixed to the battery 2 by means of a thermally shrinkable tube 8. The battery assembly is covered thereover with a flexible outer member 5. The battery pack is provided with an electrically conductive connection terminal 6 for connection to external equipments.

FIGS. 2(A) to 2(E) are illustrative of one embodiment of the battery pack production process according to the present invention.

FIG. 2(A) is illustrative of a battery 2 received in the battery pack of the present invention. As shown in FIG. 2(B), a built-in part 3 including a battery protective circuit, etc. is electrically connected to an electrode terminal of the battery 2, and connected with an electrically conductive connection terminal 6. Then, as shown in FIG. 2(C), a cushioning member 7 is placed over the built-in part 3 for covering therewith.

For the cushioning member 7, for instance, electrical insulating foamed synthetic resins such as foamed polyurethane resin and foamed polystyrene resin and foamed rubbers may be used.

Given the cushioning member of 3 to 4 mm in thickness, the built-in part can be protected against impacts generated when the battery pack falls from a height of about 1.5 m on to a concrete surface.

Then, as shown in FIG. 2(D), the cushioning member 7 is covered with a thermally shrinkable tube 8, so that the cushioning member 7 can be attached to the battery 2 by shrinking the thermally shrinkable tube by hot air.

For the thermally shrinkable tube, it is preferable to use a synthetic resin film that undergoes considerable shrink by a short-time heating at relatively low temperatures, for instance, a polypropylene film, a polyethylene film, and a polyvinyl chloride film. The thermally shrinkable tube may have a thickness of 0.05 mm to 1 mm. This ensures that the cushioning member can be fixed by the thermally shrinkable tube in place with no increase in the thickness of the battery pack.

For attachment of the cushioning member, it is acceptable to use an adhesive tape. The adhesive tape used may have a thickness equivalent to that of the thermally shrinkable tube.

Finally, as shown in FIG. 2(E), the battery assembly is covered with a flexible outer member 5 to complete a battery pack 1.

In the battery pack of the present invention, the cushioning member placed on the built-in part including a protective circuit board, etc. is fixed in place by a thin, thermally shrinkable tube or the like. It is thus possible to provide a slimline battery pack resistant to external impacts due to falling or the like.

According to the present invention as explained above, a built-in part attached to the surface of a battery and including a battery protective circuit, etc. is provided thereon with a cushioning member that undergoes restorable deformation by compression, and the cushioning member is attached to the surface of the battery by means of a thermally shrinkable tube or an adhesive tape applied on the side of a battery can. It is thus possible to provide a battery pack with little or no increase in the outer diameters by attachment of the cushioning protective member.

What we claim is:

1. A battery pack comprising a battery covered with a flexible member, wherein a built-in part including at least a protective circuit board is provided thereon with a cushioning member that is deformable by compression and restorable into shape after decompression.

2. The battery pack according to claim 1, wherein the cushioning member is at least one electrical insulating member selected from the group consisting of a foamed synthetic resin and a foamed rubber.

3. The battery pack according to claim 1, wherein the cushioning member is attached to a surface of the battery by means of a thermally shrinkable tube.

4. The battery pack according to claim 2, wherein the cushioning member is attached to a surface of the battery by means of a thermally shrinkable tube.

5. The battery pack according to claim 1, wherein the built-in part is attached to a surface of the battery by means of an adhesive tape.

6. The battery pack according to claim 2, wherein the built-in part is attached to a surface of the battery by means of an adhesive tape.
